(19) United States
(12) Patent Application Publication
(10) Pub. No.: US 2008/0108034 A1
(43) Pub. Date: May 8, 2008

(54) System and method of using fortune cookie like snack as an educational tool for school students

(75) Inventor: Joemy C. Tam, Ridge, NY (US)

Correspondence Address: Joemy C. Tam;Bldg. 5, Suite 2, 3235 Route 112, Medford, NY, 11763, US

(73) Assignee: Fortune 500 Cookie, Inc., Long Island City, NY (US)

(21) Appl. No.: 11/546,759

(22) Filed: Oct. 12, 2006

(51) Int. Cl. G09B 3/00

(52) U.S. Cl. 434/322

(57) ABSTRACT

The present invention relates to techniques of using fortune cookie like snack (i.e., cookie, chocolate, candy, or other related food item) as an educational tool for school students. In the implementation, the method includes establishing a uniquely designed knowledge database with a variety of educational materials in multiple categories, randomly printing various short question-and-answer type educational inserts, putting them into the fortune cookie like snacks, and distributing them to various academic facilities and homes. Contents within the inserts are classified into various categories, including but not limited to Mathematics, History, Geography, Languages, Sciences, Religions, and all other subjects where a short question-and-answer format within a short period of time will lead to educational value. The value proposition is that such learning tool represents a creative learning approach and can mix education with entertainment. The short question-and-answer format also facilitates enhanced memory for the knowledge acquired due to the unique environment (short questions, relaxation during snack) when the learning occurs. This approach also has the utility of serving as a quick review for specific topic before examination. The Knowledge Database has the added unique feature in which teachers and parents can enter customized questions to the database via the Internet to allow selective knowledge to be provided to their students and children.

### REFERENCES CITED

U.S. Patent Documents

| | | | |
|---|---|---|---|
| 3770278 | Nov. 6, 1973 | Mueller | 273/153 |
| 3950123 | Apr. 13, 1976 | Louie | 425/500 |
| 3983262 | Sep. 28, 1976 | Brunner, et al. | 426/502 |
| 4012184 | Mar. 15, 1977 | Ma | 425/112 |
| 4274331 | Jun. 23, 1981 | Jensen, et al. | 99/373 |
| 4339993 | Jul. 20, 1982 | Lee | 99/354 |
| 4426186 | Jan. 17, 1984 | Lee | 414/222.01 |
| 4431396 | Feb. 14, 1984 | Lee | 425/383 |
| 4591328 | May 27, 1986 | Cheung | 425/324.1 |
| 4696640 | Sep. 29, 1987 | Pitchford | 431/289 |
| 4797291 | Jan. 10, 1989 | Pierce, et al. | 426/63 |
| 5016918 | May 21, 1991 | Tidwell | 283/67 |
| D335943 | Jun. 1, 1993 | Shen | NA |
| 5407712 | Apr. 18, 1995 | D'Allura | 428/22 |
| 5530969 | Jul. 2, 1996 | Lewandowski | 2/115 |
| D436391 | Jan. 16, 2001 | Sannito, et al | NA |

### FIELD OF THE INVENTION

The present invention relates generally to the field of ADJUNCT EDUCATIONAL TOOL. This system and method uses various means to enhance the ability of students to acquire knowledge from either within or outside the school curriculum. The unique feature is that a vast amount of knowledge in multiple fields at various academic levels (Grade 1 to College) can be produced in a short question-and-answer format where students can acquire these knowledge in short form under a relaxed environment. The system also comprises a specially designed knowledge database which allows customized designed fortune cookie like snack to be delivered to individual school and household from teachers and parents.

### BACKGROUND

Fortune cookies have been around for a long time. There are several legends on how it started including the saying of early Chinese railroad builders mimicking the ancient tradition of putting happy messages into moon cakes to celebrate the Moon Festival. Since moon cakes were not readily available in the US, biscuits were used instead and that came the fortune cookies.

Another saying is that fortune cookies was introduced by Mr. Makoto Hagiwara at the Japanese Tea Garden in Golden Gate Park, San Francisco as a refreshment for tourists strolling the tea garden. It was said to be based off of a Japanese food called tsujiura senbei, which is associated with New Year festivities at Shinto Shrines. Whichever the real source of fortune cookie is, it has become a popular dessert after meals in Chinese Restaurants and provides a lot of fun to the restaurant patrons.

After dinner and regular dessert are served, customers in most Chinese restaurants will be given a cookie with an insert inside. The insert usually contains a short sentence of a humorous statement, an encouraging phrase, or an idiom. Most recently, the inserts also contain 1 or 2 Chinese characters to teach the recipient a simple Chinese vocabulary and/or several lucky numbers as hints for lottery buying.

A typical message insert is a small strip of white paper in rectangular shape that contains a short statement as described above. This small paper strip is inserted in between the two sides of the cookie, sometimes with a tail end coming out from both sides. Usually, no more than one insert is held within each fortune cookie. While fortune cookie is popular, it has never really entered other parts of the society outside the Chinese Restaurant arena. In addition, despite mild modification over the years, the contents remain more or less the same with a short encouraging note or an idiom. To the best of the inventors' knowledge, fortune cookie or related food items have never been used for formal educational purpose.

Over the years, there are a number of patents applied to fortune cookie or related subjects. The following are a brief description of the various patents, which applied to fortune cookie or related matters in various aspects:
U.S. Pat. No. 3,770,278, issued to Mueller, discloses a cookie game using a plurality of cookies packaged as a set with a fortune-like strip of paper baked inside each cookie. When all the papers in the package are arranged side-by-side in a predetermined sequence, they recreate a predetermined written composition.
U.S. Pat. No. 3,950,123, issued to Louie, discloses an apparatus for making a specialty food product such as a fortune cookie.
U.S. Pat. No. 3,983,262, issued to Brunner, et al., discloses an automatic fortune cookie folding method.
U.S. Pat. No. 4,012,184, issued to Ma, discloses a fortune cookie making machine.
U.S. Pat. No. 4,274,331, issued to Jensen, et al. discloses a wafer baking machine, which can form foldable fortune cookie from an oven.
U.S. Pat. Nos. 4,339,993, 4,426,186, and 4,431,396, issued to Lee, discloses a series of patents pertaining to a fortune cookie making machine.
U.S. Pat. No. 4,591,328, issued to Cheung, discloses a machine for forming fortune cookie shaped food item.
U.S. Pat. No. 4,696,640, issued to Pitchford, discloses a fortune candle in which a hidden message (fortune, words of endearment, game token, or a coupon) will be revealed once the candle is burned.
U.S. Pat. No. 4,797,291, issued to Pierce, et al., discloses a method of preparing a comestible with insert, held between a first and second layer of food material.
U.S. Pat. No. 5,016,918, issued to Tidwell, discloses an apparatus and method for transmitting a message using an elongate flexible sheet member having a message imprinted to be transmitted from a sender to a receiver.
U.S. Pat. No. D335943, issued to Shen, discloses the ornamental design for a fortune candy.
U.S. Pat. No. 5,407,712, issued to D'Allura, discloses a fortune flower in which growing petals of a flower will progressively release, allowing a fortune strip to unroll and emerge from within the bud as the bud opens toward full bloom.
U.S. Pat. No. 5,530,969, issued to Lewandowski, discloses a method for providing a T-shirt having a configuration resembling that of a fortune cookie
U.S. Pat. No. D436391, issued to Sannito, et al., discloses the ornamental design for an electronic fortune cookie.

However, none of the inventions and patents mentioned above, taken either singly or in any combination, is seen to describe the instant invention as claimed. To the best of the inventors' knowledge, there are no existing patents ever issued which specifically disclose a method and system of using a fortune cookie like snack as an educational tool with the objective of enhanced memory by using a short question-and-answer format in an educational setting.

Accordingly, there is a need in the field to expand the role of fortune cookie (or chocolate, candy, or related food items) for other uses. By changing the contents of the inserts from the current format into a more systemic organized educational knowledge, this mode of education could help to fulfill multiple purposes. It could be served as a snack or end of the meal gift to the school students and the information contained within can be used as an educational tool. Such use will facilitate spread of knowledge by utilizing an interesting mean to approach school students. The value proposition is that such learning tool represents a creative learning approach and can mix education and entertainment. The short question-and-answer format also facilitates enhanced memory for the knowledge acquired due to the unique nature of learning (in a relaxed environment during snack time, short question(s) and answer(s) format that allows easy memorization.) This approach also has the additional utility of serving as a quick review for specific topic before examination.

Thus, the present invention provides new and improved mean to promote education and learning and will be appeal to educators and students to satisfy the education need. The specially designed Knowledge Database also has the added feature in which teachers and parents can enter customized questions to the database via the Internet to allow selective knowledge to be provided to their students and children.

### SUMMARY OF THE INVENTION

The present invention relates to techniques of using fortune cookie like snack (i.e., cookie, chocolate, candy, or other related food item) as an educational tool for school students.

In the implementation, the method includes establishing a uniquely designed knowledge database with a variety of educational materials in multiple categories, randomly printing various short question-and-answer type educational inserts, putting these inserts into the fortune cookie like snacks, and distributing them to various academic facilities during school hours or for study at home.

Contents within the inserts are classified into various categories, including but not limited to Mathematics, History, Geography, Languages, Sciences, Religions, and all other subjects where a short question-and-answer format within a short period of time will lead to educational value. The value proposition is that such learning tool represents a creative learning approach and can mix entertainment with education. The short question-and-answer format also facilitates enhanced memory for the knowledge acquired due to the unique relaxed environment (snack time, short questions) when the learning occurs. This approach also has the utility of serving as a quick review for specific topic before examination. In addition, the Knowledge Database also has the added unique feature in which teachers and parents can enter customized questions to the database via the Internet to allow selective knowledge to be provided to their students and children.

Since there is a large geography of different ethnic areas within United States, the educational materials will be written in multiple languages, include but not limit to English, Spanish, Chinese, Japanese, French, German, and/or any other language that is suitable for each locality where the academic facilities reside.

In addition, with a variety of potential customers, it is well understood that the contents of the educational insert(s) will be written in multiple fonts and various tables, graphs, pictures, mathematical formula, scientific symbols, physical equation, chemical equation, and the like will be used as necessary.

To entice usage and to make the educational experience interesting, instead of the traditional rectangular paper strip, the educational inserts will be made into various size, shape, color, and texture. Also, for efficiency purpose, the number of inserts could be more than one should it happen that the academic setting requests such approach.

Despite standard size and shape are readily established for traditional fortune cookie, it would be desirable to vary the size, shape, color, and texture of the current proposed fortune cookie snack to attract school students to read and learn the contents contained within. With this mandate, the inserts might be folded in various creative way (e.g., spiral, cylindrical, triangular) as long as it can be held securely within the snack and allowed easy retrieval. Lastly, for hygienic reason, each fortune cookie like snack will be wrapped individually. However, one or more snacks could be packed in container of various size, shape, color, or material to attract consumption and usage.

As frequent snacks may lead to potential concerns for excess calories or weight gain, one solution is that some of the fortune cookie like snacks will be made of low calorie food materials to give customers more choices. While not to be a specific claim by itself, some snacks could be made as low fat, low cholesterol, low sodium, using substitute sugars, or with additional vitamins and minerals to minimize calorie, fat, and salt concerns yet allow maximum nutritional values.

The present invention also provides methods for efficiently producing short educational materials for insertion into different fortune cookie like snack by using a specially designed computer program to produce thousands of inserts quickly in various categories from a central databank in a random fashion. One important aspect of the current invention pertains to such computer program recorded on a computer-readable medium that includes instructions operable to cause a programmable processor to perform a technique according to the invention. The instructions cause the computer processor to input thousands of short question-and-answer information from various sources such as books, dictionaries, encyclopedia, and various educational materials from the public domain. The program then sorts the data acquired into pre-determined categories and different difficulty levels (Grade 1 to College).

The computer program then extracts the information from the knowledge databank in various categories such as Mathematics, History, Geography, Languages, Sciences, Religions, and all other subjects and produces them in a short question-and-answer format educational inserts. Accordingly, the computer program will randomly print multiple questions on the front side of a sheet of paper and the corresponding answers to these questions on the back side of the paper in a location approximates these questions. This will allow easy separation and division of individual educational inserts and inserted them into the fortune cookie like snacks. The computer program is specially designed and advantageously includes all the unique features mentioned above.

A further aspect of the invention pertains to a method of efficiently delivering the final products to individual academic facilities from the specially designed computer system. The technique includes establishing a uniform closing time for submitting orders of various categories of educational materials from the academic facilities, asking for a monthly supply count, associating educational inserts for different fortune cookie categories by various regions, and group the orders together such that orders of similar categories and quantities are produced together. This in turn will allow efficient shipping and regional delivery to academic facilities in nearby neighborhood. This method has the advantage of efficient logistic flow and allows for optimal cost-efficient production and delivery to minimize production expenses.

The current invention provides many advantages. Students benefit from an innovative educational tool such that a snack of either a cookie, chocolate, candy, or related food can provide educational value. This allows creative learning and enhanced memorization of potential difficult to learn subjects. Educators can also benefit because their students will be attracted to a different mode of acquiring knowledge, whether it is within or outside the normal academic curriculum.

The system and method are universal in their application and can be used to satisfy any education setting where a short question-and-answer strip held within a selected food item can be used for educational purpose. It is understood that our services are not limited to the list given above any other modifications and expansions are possible without departure from the claims given above.

The details of one or more embodiments of the invention are set forth in the accompanying drawings and the description below. Other features and benefits of the current invention will be apparent from the detailed description and the drawings, and from the claims.

### BRIEF DESCRIPTION OF THE DRAWINGS

The present invention is illustrated by way of example in the following drawings in which like references indicate similar elements. The following drawings disclose various embodiments of the present invention for purposes of illustration only and are not intended to limit the scope of the invention.

In the figures,

FIG. 1 illustrates the knowledge learning chain from an academic facility to the Fortune 500 Cookies Knowledge Database.

FIG. 2 shows the Fortune 500 Cookies Knowledge Database, which creates educational messages for insertion into the fortune cookie like snacks.

FIG. 3 shows samples of the fortune cookie like snacks, which contain information of various knowledge fields.

### DETAILED DESCRIPTION

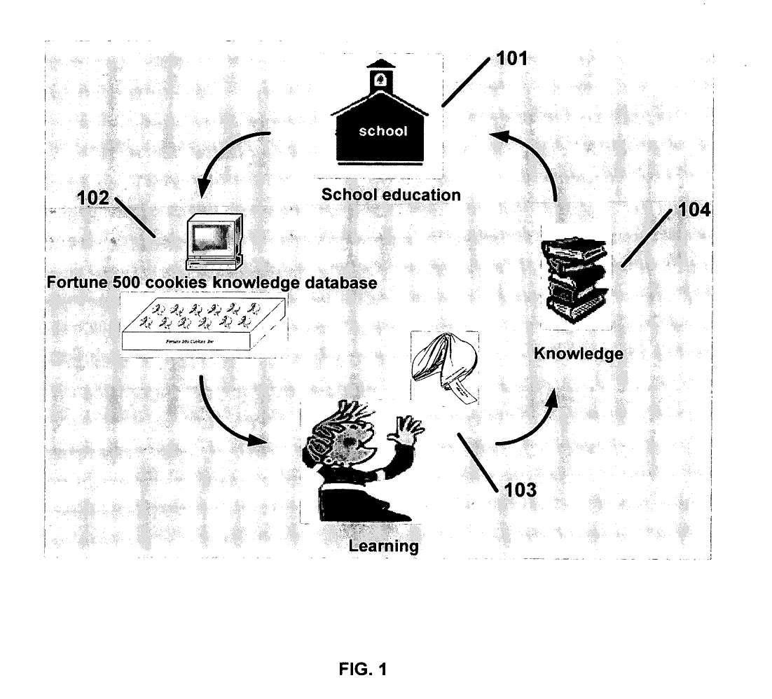

FIG. 1 explains how the fortune cookie like snack helps students learn. First, students learn basic knowledge from their regular school (101). Then Fortune 500 Cookies Knowledge Database (102) creates review questions and/or related information messages which are inserted into the fortune cookie like snack (103). Students use the didactic snack as a adjunct educational tool for learning while consuming the snack at their leisure. Under such relaxed environment when students are consuming the fortune cookie like snack, they read the educational inserts contained within the snack and learn the knowledge (104).

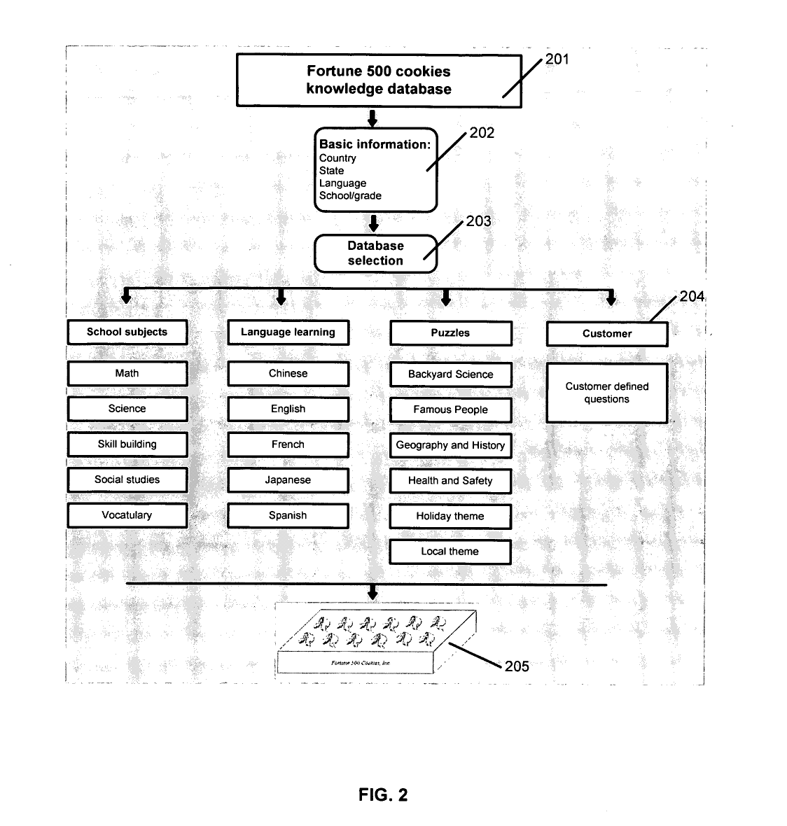

FIG. 2 shows the schematic diagram of the Fortune 500 Cookies Knowledge Database (201). First, customer information (202) is used to select a specific database subset (203) for students in different geographical location and academic grade level at each school. For illustration purpose, the database contains four major categories which are school subjects, language learning, puzzles, and custom defined questions. The school subject category contains questions to help students review and learn school related topics. The language leaning category helps students increase vocabulary or phrases of different languages. The puzzles category contains mixed knowledge from history to local theme. The customer category (204) is designed for parents and teachers to create their owned questions. They can upload their specially designed questions via the Internet or other means to input into the Fortune 500 Cookies Knowledge Database. After the data are input, the database will then create educational messages of those customer defined questions to be inserted into the fortune cookie like snacks. The uniquely designed “customer defined” Fortune 500 cookies provide parents and teachers a creative way to educate their children and students for knowledge that they handpicked themselves.

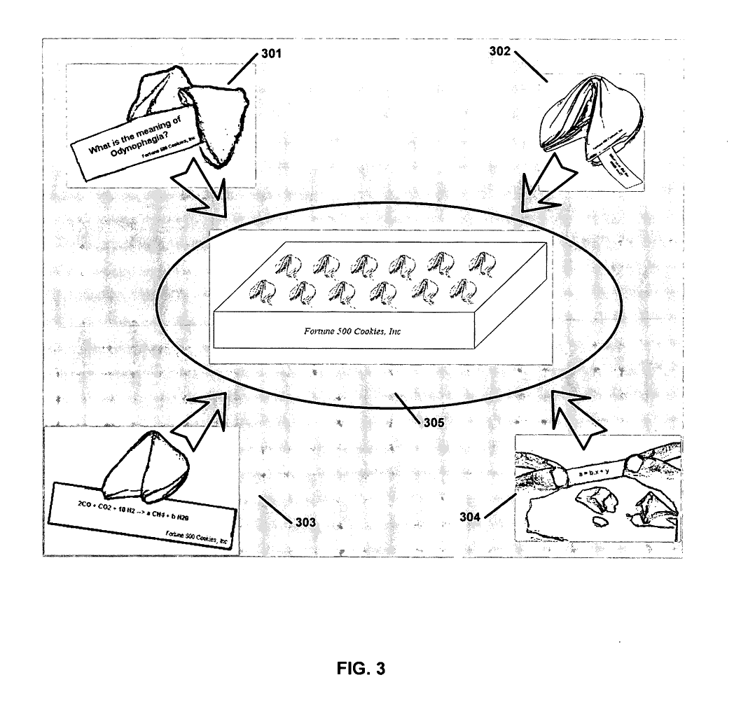

FIG. 3 contains samples of the Fortune 500 cookies (305). The inserts contain various questions, for example vocabulary (301), history (302), chemistry (303), and mathematics (304).

A number of implementations of the invention have been described. Nevertheless, it will be understood that various modifications may be made without departing from the spirit and scope of the invention. Accordingly, other embodiments are within the scope of the claims outlined in this patent.

What is claimed is:

1. A system and method for using specially designed educational insert(s) into a fortune cookie like snack (cookie, chocolate, candy, or other related food) to educate school students on various knowledge.

2. The system and method of claim 1 wherein said the contents of the educational materials written in the inserts could be of any topics, include but not limited to Mathematics, History, Geography, Languages, Sciences, Religions, and all other subjects where a short question-and-answer format in a short period of time will lead to educational value.

3. The system and method of claim 1 wherein said the educational insert(s) can be in any language, include but not limit to English, Spanish, Chinese, Japanese, French, German, and/or any other language that is suitable for each locality where the academic facilities reside.

4. The system and method of claim 1 wherein said the educational insert(s) can be written in any fonts and various tables, graphs, pictures, mathematical formula, scientific symbols, physical equation, chemical equation, and the like can be used as necessary.

5. The system and method of claim 1 wherein said the educational insert(s) can be of any size, shape, colors, and texture to attract school students to read and learn the contents contained within.

6. The system and method of claim 1 wherein said the educational insert(s) can be one or more.

7. The system and method of claim 1 wherein said the fortune cookie like snack will be folded in a way and shape where an insert can be held securely within, yet allow for easy retrieval.

8. The system and method of claim 1 wherein said the fortune cookie like snack can be of any size, shape, color, and texture to attract school students to read and learn the contents contained within.

9. The system and method of claim 1 wherein said the fortune cookie like snack will be individually wrapped for hygienic reason and can be packaged in various quantities (one or more) and in container of various size, shape, color, and materials to attract consumption and usage.

10. The system and method of claim 1 wherein said the contents of the educational materials contained in the insert(s) are produced randomly by a specially designed computer program.

11. The system and method of claim 10 wherein said the computer program can be adjusted to individual academic facility need with the contents attuned to the demand of individual retail outlets (cafeteria, snack bar, bookstores, etc) at the academic facility.

12. The computer program product of claim 10 wherein said special instructions to cause a programmable processor to coordinate paper stock for printing the educational inserts to address the ordering status of the individual academic facility is included.

13. The computer program product of claim 10 wherein said special instructions to cause a programmable processor to designate particular printing press outputs for product delivery at each academic facility is included.

14. The computer program product of claim 10 wherein said the uniquely designed knowledge database has the added feature in which teachers and parents can enter customized designed questions to the database via the Internet to allow selective knowledge to be provided to their students and children.
